(19) United States
(12) Patent Application Publication
(10) Pub. No.: US 2020/0258171 A1
(43) Pub. Date: Aug. 13, 2020

(54) System and Method for Interfacing Acquiring Entities and Realtors

(71) Applicant: The Toronto-Dominion Bank, Toronto (CA)

(72) Inventors: Patrick GIBBON, Ancaster (CA); James Zachary PRYOR, Toronto (CA); Jonathan K. BARNETT, Oakville (CA); Roy D'SOUZA, Oakville (CA); William Stewart James LAW, St. Catherines (CA); Christopher Arthur Holland McALPINE, Grimsby (CA); Ethan Christopher McALPINE, Grimsby (CA); Maria VERNA, Vaughan (CA); Patrick Robert GORALSKI, London (CA); Cathleen Ruth CARREL, Minesing (CA); Rohan ANAND, Toronto (CA); Christy Ann DYBA, Markham (CA); Dheeraj JAGTIANI, Toronto (CA); Ali HAFEZI, Toronto (CA); Ashkan ALAVI-HARATI, Markham (CA)

(21) Appl. No.: 16/275,178

(22) Filed: Feb. 13, 2019

(51) Int. Cl. G06Q 50/16; G06F 16/9535

(52) U.S. Cl. CPC G06Q 50/16; G06F 16/9535

(57) ABSTRACT

A system and method are provided for interfacing home buyers and realtors. The method includes, receiving a first signal including financial data and a second signal including personal profile data for each acquiring entity associated with the electronic platform, storing a database of realtor profile data for each of a plurality of the realtors, providing a realtor search tool to receive search criteria, receiving search criteria and using the received search criteria and the realtor profile data to generate a search result list comprising at least one recommended realtor, sending the search result list to the acquiring entity, receiving a request for a selected realtor, providing controlled access to the financial data and the personal profile data to the selected realtor, and enabling at least one step in an acquisition process to be electronically executed or electronically initiated with a financial institution computing system.

### TECHNICAL FIELD

The following relates generally to interfacing acquiring entities and realtors.

### BACKGROUND

There are typically several stages in purchasing a home or other property, including searching for a suitable property, and financing the property through a lender, e.g., a financial institution. Currently, there may be a disconnect between these two stages. The property search may be carried out with the assistance of a realtor (including real estate agents and/or real estate brokers) that may not have enough knowledge of the financial situation of the acquiring entity. Also, that realtor may not be the best fit for the acquiring entity and/or the target location, type of property, etc., since many individuals hire a realtor based on a referral or existing knowledge or experience. The financial institution may not be involved at the property search stage but may become involved when the acquiring entities find a property and begin the process of making an offer to purchase. The financial institution may independently assess the property and vet the acquiring entity (or perform additional vetting if the acquiring entity has been pre-qualified). Many transactions are found to fail at this point for various reasons, such as a financial reason.

### BRIEF DESCRIPTION OF THE DRAWINGS

Embodiments will now be described with reference to the appended drawings wherein:

FIG. 1 is a schematic diagram of an example computing environment.

FIG. 2 is a block diagram of an example configuration of a realtor referral and interface platform.

FIG. 3 is a block diagram of an example configuration of a client computing device associated with an acquiring entity.

FIG. 4 is a block diagram of an example configuration of a realtor computing device associated with a realtor.

FIG. 5 is a flow diagram of an example of computer executable instructions for processing profile data to generate recommendations and interface acquiring entities with realtors.

FIG. 6 is a flow diagram of an example of computer executable instructions for executing matching and recommendation processes.

FIG. 7 is a flow diagram of an example of computer executable instructions for communicating proposed recommendations to realtors.

FIG. 8 is a flow diagram of an example of computer executable instructions for obtaining access to data for populating a client profile.

FIG. 9 is a flow diagram of an example of computer executable instructions for monitoring and storing home search data and providing home search data to realtors.

FIG. 10 is an example of a graphical user interface of a home buying dashboard.

FIG. 11 is an example of a graphical user interface of a realtor search tool.

FIG. 12 is an example of a graphical user interface of a virtual chat session.

FIG. 13 is an example of a graphical user interface of a document sharing tool.

### DETAILED DESCRIPTION

It will be appreciated that for simplicity and clarity of illustration, where considered appropriate, reference numerals may be repeated among the figures to indicate corresponding or analogous elements. In addition, numerous specific details are set forth in order to provide a thorough understanding of the example embodiments described herein. However, it will be understood by those of ordinary skill in the art that the example embodiments described herein may be practiced without these specific details. In other instances, well-known methods, procedures and components have not been described in detail so as not to obscure the example embodiments described herein. Also, the description is not to be considered as limiting the scope of the example embodiments described herein.

Currently, there may be a disconnect between searching for a suitable property and financing the property through a lender. The property search may be carried out with the assistance of a realtor that may not have enough knowledge of the financial situation of the acquiring entity. The financial institution may not be involved at the property search stage but may become involved when the acquiring entities find a property and begin the process of making an offer to purchase. There exists a need to have a platform that can enable prospective buyers to search for realtors, receive recommendations for suitable realtors, and provide an interface for the buyers and realtors to collaborate and participate in the home buying process.

A platform is provided for integrating aspects of the abovementioned stages of home buying. In an example embodiment, the platform can be provided by or in connection with a financial institution, where the financial institution can leverage its large amount of data and networks of clients. Realtors may be added to a database where they are rated and reviewed by the clients. A client may be provided with the best realtor match, based on his/her qualifications and other realtor data. Accredited realtors may also be given limited access to data held by the platform, to vet the home buyer. In addition, incentives may be offered to both the realtor and the client to use the platform. Customers can earn loyalty points as they use the platform, use the associated financial institution for financing, or through an affiliated third party loyalty program. The platform may also provide communication and document sharing tools to facilitate the home buying process, including the integrated searching and financing aspects for the client and the matched realtor.

Certain example systems and methods described herein are able to enable acquiring entities such as a home buyer to search for and receive recommendations for a realtor, provide controlled access to financial and personal profile data to a selected realtor, and interface the acquiring entity with a selected realtor. In one aspect, there is provided a device for interfacing acquiring entities and realtors. The device includes a processor, a communications module coupled to the processor, and a memory coupled to the processor. The memory stores computer executable instructions that when executed by the processor cause the processor to provide via the communications module an electronic platform comprising a first interface for interacting with one or more realtors, a second interface for interacting with acquiring entities via acquiring entity electronic communication devices, and a third interface for communication with a financial institution computing system. The memory also stores computer executable instructions that when executed by the processor cause the processor to receive via the third interface of the communications module a first signal including financial data and a second signal including personal profile data for each acquiring entity associated with the electronic platform and store a database of realtor profile data for each of a plurality of the realtors. The realtor profile data includes a plurality of metrics. The memory also stores computer executable instructions that when executed by the processor cause the processor to provide via the second interface of the communications module a realtor search tool to receive search criteria and receive via the second interface of the communications module a third signal from the acquiring entity including search criteria and use the received search criteria and the realtor profile data to generate a search result list comprising at least one recommended realtor that satisfies at least one search criterion and satisfies at least one realtor metric. The memory also stores computer executable instructions that when executed by the processor cause the processor to send via the second interface of the communications module a fourth signal including the search result list to the acquiring entity electronic communication device, receive via the second interface of the communications module a fifth signal including a request for a selected realtor, provide controlled access to the financial data and the personal profile data to the selected realtor via the first interface of the communications module, and enable via the third interface of the communications module at least one step in an acquisition process to be electronically executed or electronically initiated with the financial institution computing system, using the first interface or the second interface of the communications module.

In another aspect, there is provided a method of interfacing home buyers and realtors. The method includes providing via a communications module an electronic platform comprising a first interface for interacting with one or more realtors, a second interface for interacting with acquiring entities via acquiring entity electronic communication devices, and a third interface for communication with a financial institution computing system. The method also includes receiving via the third interface of the communications module a first signal including financial data and a second signal including personal profile data for each acquiring entity associated with the electronic platform and storing a database of realtor profile data for each of a plurality of the realtors. The realtor profile data includes a plurality of metrics. The method also includes providing via the second interface of the communications module a realtor search tool to receive search criteria and receiving via the second interface of the communications module a third signal from the acquiring entity including search criteria and use the received search criteria and the realtor profile data to generate a search result list comprising at least one recommended realtor that satisfies at least one search criterion and satisfies at least one realtor metric. The method also includes sending via the second interface of the communications module a fourth signal including the search result list to the acquiring entity electronic communication device, receiving via the second interface of the communications module a fifth signal including a request for a selected realtor, providing controlled access to the financial data and the personal profile data to the selected realtor via the first interface of the communications module, and enabling via the third interface of the communications module at least one step in an acquisition process to be electronically executed or electronically initiated with the financial institution computing system, using the first interface or the second interface of the communications module.

In another aspect, there is provided non-transitory computer readable medium for interfacing home buyers and realtors. The computer readable medium includes computer executable instructions for providing via a communications module an electronic platform comprising a first interface for interacting with one or more realtors, a second interface for interacting with acquiring entities via acquiring entity electronic communication devices, and a third interface for communication with a financial institution computing system. The computer readable medium also includes computer executable instructions for receiving via the third interface of the communications module a first signal including financial data and a second signal including personal profile data for each acquiring entity associated with the electronic platform and storing a database of realtor profile data for each of a plurality of the realtors. The realtor profile data includes a plurality of metrics. The computer readable medium also includes computer executable instructions for providing via the second interface of the communications module a realtor search tool to receive search criteria and receiving via the second interface of the communications module a third signal from the acquiring entity including search criteria and use the received search criteria and the realtor profile data to generate a search result list comprising at least one recommended realtor that satisfies at least one search criterion and satisfies at least one realtor metric. The computer readable medium also includes computer executable instructions for sending via the second interface of the communications module a fourth signal including the search result list to the acquiring entity electronic communication device, receiving via the second interface of the communications module a fifth signal including a request for a selected realtor, providing controlled access to the financial data and the personal profile data to the selected realtor via the first interface of the communications module, and enabling via the third interface of the communications module at least one step in an acquisition process to be electronically executed or electronically initiated with the financial institution computing system, using the first interface or the second interface of the communications module.

In certain example embodiments, the plurality of realtors may be provided with limited access to the financial and personal profile data to vet at least one home buyer according to financial viability. The device may receive via the communications module a sixth signal including a request to omit a particular realtor from recommendations provided to at least one acquiring entity based on the vetting.

In certain example embodiments, the data provided to the selected realtor may include data associated with a mortgage pre-approval.

In certain example embodiments, the at least one step in the acquisition process may include initiating a mortgage approval process with the financial institution computing system. The at least one step in the acquisition process may include a home appraisal associated with the mortgage approval process.

In certain example embodiments, home search data for at least one acquiring entity may be stored and access to the home search data may be provided to the selected realtor via the first interface of the communications module, to assist in a home buying process.

In certain example embodiments, access to the financial and personal profile data for the selected realtor may be increased in response to at least one event. The at least one event may include at least one of an agreement to represent the acquiring entity, an instruction or permission provided by the acquiring entity, and a regulatory requirement being satisfied.

In certain example embodiments at least one step in a real estate transaction associated with a financing may be enabled to be executed or initiated using the first or second interface of the communications module. The at least one step in the real estate transaction may include at least one of a purchase offer, a home inspection, and acquiring home insurance.

In certain example embodiments, realtor feedback may be obtained via the second interface of the communications module, and the database of realtor profile data may be updated according to the feedback.

In certain example embodiments, a document sharing tool between the realtors and the acquiring entities that uses the first and second interfaces may be provided via the communications module.

In certain example embodiments, a communication tool between the realtors and the acquiring entities that uses the first and second interfaces may be provided via the communications module.

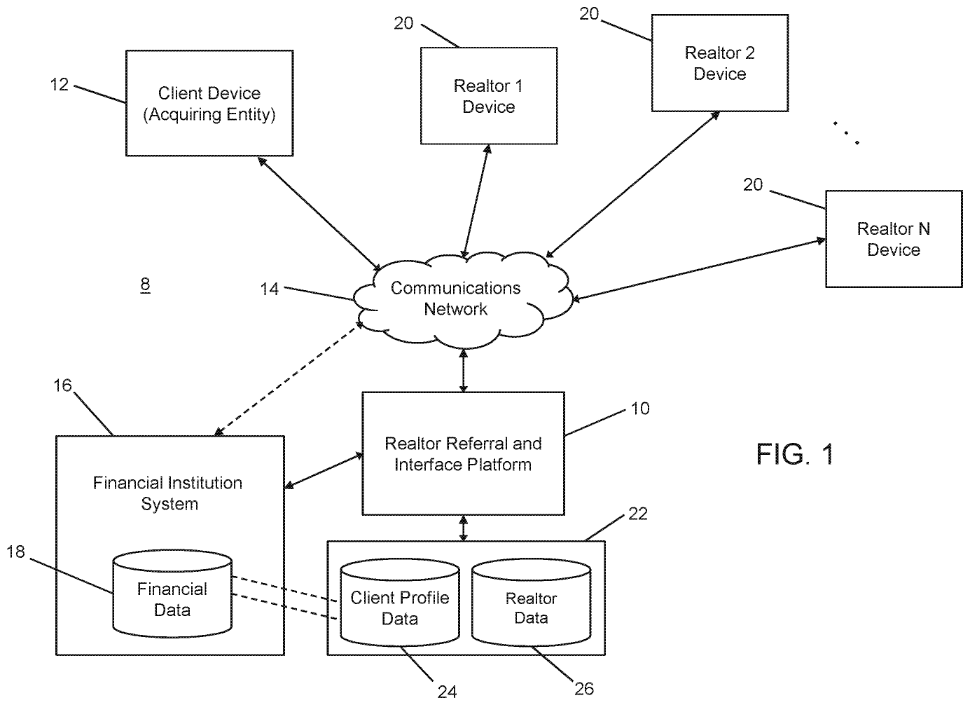

FIG. 1 illustrates an exemplary computing environment 8. In one aspect, the computing environment 8 may include a realtor referral and interface platform 10 (referred to as “the platform 10” hereinafter), one or more client devices 12, and a communications network 14 connecting one or more components of the computing environment 8. The computing environment 8 may also include one or more realtor devices 20. In the example shown in FIG. 1, N realtor devices 20 are shown and each realtor device 20 may be associated with one or more realtors (e.g., one or more realtors practicing within a same real estate office). Each realtor participating in the computing environment 8 has or has access to a realtor device 20 in order to interface with the platform 10.

The computing environment 8 may also include a financial institution system 16 (e.g., commercial bank) that provides financial services accounts to users and processes financial transactions associated with those financial service accounts. While several details of the financial institution system 16 have been omitted for clarity of illustration, shown in FIG. 1 is a datastore (also referred to as a database, memory or memory element) that stores financial data 18. The financial data 18 may be associated with users of the client devices 12 (who may also be realtors in some example embodiments). The financial data 18 may include any data related to or derived from financial values or metrics associated with customers of the financial institution 16, for example, account balances, transaction histories, line of credit available, credit scores, mortgage balances, affordability metrics, investment account balances, investment values and types, among many others. The financial data 18 may also be associated with users of the realtor devices 20.

The computing environment 8 may also include a datastore 22. In the example shown in FIG. 1, the datastore 22 may be used to store client profile data 24 and realtor data 26. The client profile data 24 may be used to store data accumulated by or provided to the platform 10 and which is associated with a user of a client device 12. The client profile data 24 may be mapped to corresponding financial data 18 for that user (as illustrated using dashed lines in FIG. 1) and/or may include some of the financial data 18. The client profile data 24 can include both data that is associated with a client as well as data that is associated with one or more user accounts for that client as recognized by the platform 10. The data associated with a client may include, without limitation, demographic data (e.g., age, gender, income, location, etc.), preference data input by the client (e.g., hobbies, likes, dislikes, etc.), and inferred data generated through machine learning, modeling, pattern matching, or other automated techniques. The client profile data 24 may also include historical interactions and transactions associated with the platform 10, e.g., login history, search history, communication logs, document sharing metrics, etc. The client profile data 24 may also include documents, media content or other files that are being shared on the platform 10 or otherwise stored for the client.

In this example, N realtor devices 20 are shown and data for each realtor using such realtor devices 20 has realtor data 26 stored by the platform 10. The realtor data 26 for a particular realtor may include various types of data, such as, without limitation, name, company, gender, ratings (if available), realtor feedback (e.g., provided by users of the platform 10), geographic area of operation, contacts relevant to the platform 10 (e.g., other advisors that utilize the platform 10), stated or inferred experiences in certain services or product types. For example, realtor data 26 for a real estate firm may include a roster of agents, their personal details, geographical areas in which they represent clients, whether their experience lies in condominium developments versus single family dwellings, rankings from websites or industry organizations, customized data entered by the platform 10 (e.g., personality traits, past success matches with clients, etc.), among other types of data. The realtor data 26 may be updated and refined over time using external sources such as rankings or ratings services, or internal sources such as successful or unsuccessful matches(s) enabled via the platform 10.

It can be appreciated that the datastore 22 is shown separately from the platform 10 for illustrative purposes only and may also be at least partially stored within a database, memory, or portion thereof within the platform 10. It can also be appreciated that while the platform 10 and financial institution system 16 are shown as separate entities in FIG. 1, they may also be part of the same system. For example, the platform 10 can be hosted and provided within the financial institution system 16.

Client devices 12 may be associated with one or more users. Users may be referred to herein as acquiring entities, home buyers, or other entities associated with an exchange activity such as a home buying process, and which is interfaced with a realtor and associated realtor device 20. The computing environment 8 may include multiple client devices 12, each client device 12 being associated with a separate user or associated with one or more users. In certain embodiments, a user may operate client device 12 such that client device 12 performs one or more processes consistent with the disclosed embodiments. For example, the user may use client device 12 to engage and interface with a realtor to assist in purchasing a home. In certain aspects, client device 12 can include, but is not limited to, a personal computer, a laptop computer, a tablet computer, a notebook computer, a hand-held computer, a personal digital assistant, a portable navigation device, a mobile phone, a wearable device, a gaming device, an embedded device, a smart phone, a virtual reality device, an augmented reality device, third party portals, an automated teller machine (ATM), and any additional or alternate computing device, and may be operable to transmit and receive data across communication network 14.

Communication network 14 may include a telephone network, cellular, and/or data communication network to connect different types of client devices 12 and different types of advisor systems (e.g., realtor devices 20). For example, the communication network 14 may include a private or public switched telephone network (PSTN), mobile network (e.g., code division multiple access (CDMA) network, global system for mobile communications (GSM) network, and/or any 3G, 4G, or 5G wireless carrier network, etc.), WiFi or other similar wireless network, and a private and/or public wide area network (e.g., the Internet).

In one embodiment, platform 10 may be one or more computer systems configured to process and store information and execute software instructions to perform one or more processes consistent with the disclosed embodiments. In certain embodiments, although not required, platform 10 may be associated with one or more business entities. In certain embodiments, platform 10 may represent or be part of any type of business entity. For example, platform 10 may be a system associated with a commercial bank (e.g., financial institution system 16), a retailer, or some other type of business.

Referring back to FIG. 1, the platform 10 and/or financial institution system 16 may also include a cryptographic server (not shown) for performing cryptographic operations and providing cryptographic services (e.g., authentication (via digital signatures), data protection (via encryption), etc.) to provide a secure interaction channel and interaction session, etc. Such a cryptographic server can also be configured to communicate and operate with a cryptographic infrastructure, such as a public key infrastructure (PKI), certificate authority (CA), certificate revocation service, signing authority, key server, etc. The cryptographic server and cryptographic infrastructure can be used to protect the various data communications described herein, to secure communication channels therefor, authenticate parties, manage digital certificates for such parties, manage keys (e.g., public and private keys in a PKI), and perform other cryptographic operations that are required or desired for particular applications of the platform 10 and financial institution system 16. The cryptographic server may be used to protect the financial data 18, client profile data 24, and realtor data 26 by way of encryption for data protection, digital signatures or message digests for data integrity, and by using digital certificates to authenticate the identity of the users and client devices 12 and realtor devices 20 with which the platform 10 communicates to inhibit data breaches by adversaries. It can be appreciated that various cryptographic mechanisms and protocols can be chosen and implemented to suit the constraints and requirements of the particular deployment of the platform 10 as is known in the art.

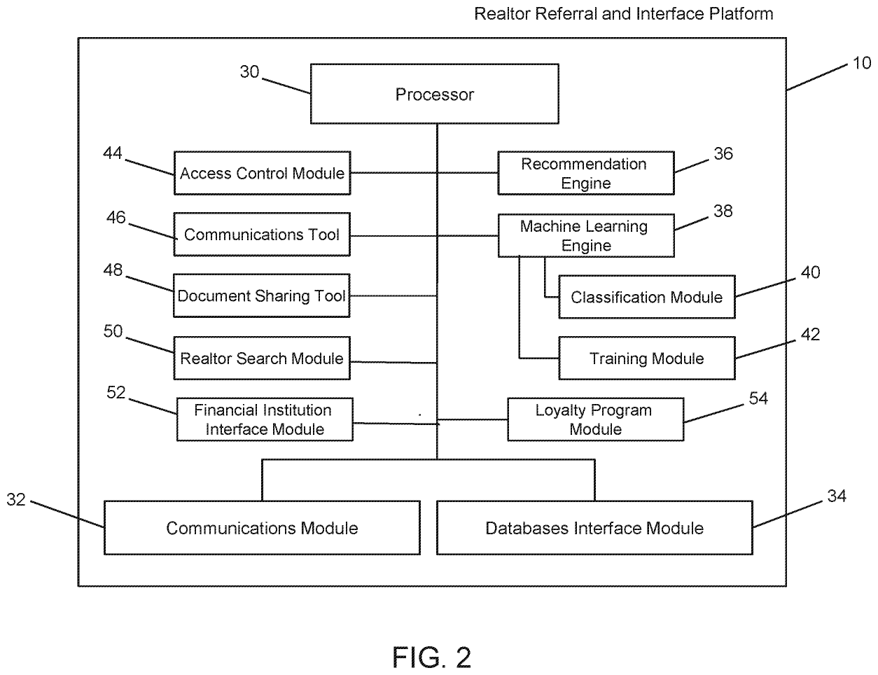

In FIG. 2, an example configuration of the platform 10 is shown. In certain embodiments, the platform 10 may include one or more processors 30, a communications module 32, and a database interface module 34 for interfacing with the datastore 22 to retrieve and store data. Communications module 32 enables the platform 10 to communicate with one or more other components of the computing environment 8, such as client device 12 or realtor devices 20 (or one of its components), via a bus or other communication network, such as the communication network 14. While not delineated in FIG. 2, the platform 10 includes at least one memory or memory device that can include a tangible and non-transitory computer-readable medium having stored therein computer programs, sets of instructions, code, or data to be executed by processor 30. FIG. 2 illustrates examples of modules, tools and engines stored in memory on the platform 10 and operated by the processor 30. It can be appreciated that any of the modules, tools, and engines shown in FIG. 2 may also be hosted externally and be available to the platform 10, e.g., via the communications module 32. In the example embodiment shown in FIG. 2, the platform 10 includes a recommendation engine 36, a machine learning engine 38, a classification module 40, a training module 42, an access control module 44, a communications tool 46, a document sharing tool 48, a realtor search module 50, a financial institution interface module 52, and a loyalty program module 54.

The recommendation engine 36 is used by the platform 10 to generate one or more realtor recommendations for a client device 12. The recommendation engine 36 can access the client profile data 24 and realtor data 26 via the databases interface module 34 and apply one or more matching processes to generate the recommendation(s). The recommendation engine 36 may utilize or otherwise interface with the machine learning engine 38 to both classify data currently being analyzed to generate a recommendation, and to train classifiers using data that is continually being processed and accumulated by the platform 10.

The machine learning engine 38 may also perform operations that classify the client profile data 24 and realtor data 26 in accordance with corresponding classifications parameters, e.g., based on an application of one or more machine learning algorithms to each of the groups of profile data 24, 26 (also referred to herein as “profile content”). The machine learning algorithms may include, but are not limited to, a one-dimensional, convolutional neural network model (e.g., implemented using a corresponding neural network library, such as Keras®), and the one or more machine learning algorithms may be trained against, and adaptively improved using, elements of previously classified profile content identifying suitable matches between users and potential realtors. Subsequent to classifying the profile content, the recommendation engine 36 may further process each element of the profile content to identify, and extract, a value characterizing the corresponding one of the classification parameters, e.g., based on an application of one or more additional machine learning algorithms to each of the elements of the profile content. By way of the example, the additional machine learning algorithms may include, but are not limited to, an adaptive natural language processing algorithm that, among other things, predicts starting and ending indices of a candidate parameter value within each element of profile content, extracts the candidate parameter value in accordance with the predicted indices, and computes a confidence score for the candidate parameter value that reflects a probability that the candidate parameter value accurately represents the corresponding classification parameter. As described herein, the one or more additional machine learning algorithms may be trained against, and adaptively improved using, the locally maintained elements of previously classified profile content. Classification parameters may be stored and maintained using the classification module 40, and training data may be stored and maintained using the training module 42.

In some instances, classification data stored in the classification module 40 may identify one or more parameters, e.g., “classification” parameters, that facilitate a classification of corresponding elements or groups of recognized profile content based on any of the exemplary machine learning algorithms or processes described herein. The one or more classification parameters may correspond to parameters that can indicate an affinity or compatibility between users and potential realtors. For example, a target geographical area preference for a user's homebuying search can be correlated or deemed compatible or not with certain geographic areas targeted by a realtor or in which that realtor has received positive reviews, completed several transactions, etc.

In some instances, the additional, or alternate, machine learning algorithms may include one or more adaptive, natural-language processing algorithms capable of parsing each of the classified portions of the profile content and predicting a starting and ending index of the candidate parameter value within each of the classified portions. Examples of the adaptive, natural-language processing algorithms include, but are not limited to, natural-language processing models that leverage machine learning processes or artificial neural network processes, such as a named entity recognition model implemented using a SpaCy® library.

Examples of these adaptive, machine learning processes include, but are not limited to, one or more artificial, neural network models, such as a one-dimensional, convolutional neural network model, e.g., implemented using a corresponding neural network library, such as Keras®. In some instances, the one-dimensional, convolutional neural network model may implement one or more classifier functions or processes, such a Softmax® classifier, capable of predicting an association between an element of profile content (e.g., an address used in a real estate listing search) and a single classification parameter (e.g., a region of interest) and additionally, or alternatively, multiple classification parameters (e.g., a property tax level and a region of interest).

Based on the output of the one or more machine learning algorithms or processes, such as the one-dimensional, convolutional neural network model described herein, machine learning engine 38 may perform operations that classify each of the discrete elements of profile content as a corresponding one of the classification parameters, e.g., as obtained from classification data stored by the classification module 40.

The outputs of the machine learning algorithms or processes may then be used by the recommendation engine 36 to find one or more best matches for a realtor. As discussed in greater detail below, the matching process implemented by the recommendation engine 36 may operate iteratively. For example, the recommendation engine 36 may be initiated at each iteration and proceed to recommend, confirm, and attempt to engage a realtor until a match is accepted by the user and confirmed by the realtor.

In another example embodiment, the recommendation engine 36 may provide multiple ranked matches in a single iteration such that if a highest match is not confirmed, the alternative matches can be attempted. On the other hand, the multiple ranked matches also enable a user to choose a match that is not necessarily the highest ranked.

Referring again to FIG. 2, the access control module 44 may be used to apply a hierarchy of permission levels or otherwise apply predetermined criteria to determine what profile data can be shared with which entity in the computing environment 8. For example, the platform 10 may have been granted access to certain sensitive financial data 18 for a user, which is associated with a certain client device 12 in the computing environment 8. When communicating with the realtor devices 20, such access control measures can be applied to restrict the sharing of information with such realtor devices 20. Similarly, the client profile data 24 may include potentially sensitive information such as age, date of birth, or nationality, which may not necessarily be needed by the realtor until later stages of their engagement. For example, a realtor may not require financial data 18 until forms are required for a bid or mortgage pre-approval, whereas some general personal information may be required to enter into a realtor representation agreement. As such, the access control module 44 can be used to control the sharing of certain client profile data 24 (and/or financial data 18) based on stages or events in the acquisition process. That is, as the relationship between the acquiring entity and the realtor changes, events representing or causing these changes in the relationship can trigger different levels of access control to the client profile data 24 and/or financial data 18. This can include providing additional integration between the realtor and the financial institution on behalf of the acquiring entity, in response to events indicative of a deeper or more formalized relationship.

The platform 10 may also include a communications tool 46 that is provided to enable entities in the computing environment 8 to communicate with each other, e.g., via an instant messaging or chat interface. The platform 10 may also include a document sharing tool 48 to enable entities in the computing environment 8 to share documents and other files to assist with the acquisition process. For example, the user may upload and share example listings and a realtor may upload agreements, offers, or counter-offers. The communications tool 46 and the document sharing tool 48 may include their own access control functionality or may utilize and coordinate with the access control module 44 for such functionality. It can be appreciated that the delineation between the access control module 44, communications tool 46, and document sharing tool 48 as shown in FIG. 2 is for illustrative purposes. The platform 10 may also include a realtor search module 50 to provide a graphical user interface (GUI) that enables users to search for a realtor based on the realtor data 26, which can initiate the recommendation engine 36 to return relevant realtor search results to the user.

The platform 10 may also include a financial institution interface module 52 to provide a GUI or application programming interface (API) connectivity to communicate with the financial institution system 16 to obtain financial data 18 for a certain user. The platform 10 may also include a loyalty program module 54 to track interactions with the platform 10 to reward the user through one or more loyalty programs. For example, a realtor may offer a loyalty program through the platform 10 to reward users for engaging with their real estate office or company. The loyalty program module 54 may also rewards realtors for engaging with the platform 10. Similarly, the financial institution associated with the financial institution system 16 may integrate and affiliate their loyalty program with the platform 10. Moreover, other third-party loyalty programs (that may or may not be affiliated with the realtor or financial institution) may also provide a loyalty program offering through the platform 10, using the loyalty program module 54. It can be appreciated that the realtor search module 50, financial institution module 52 and loyalty program module 54 may also provide a web browser-based interface, an application or “app” interface, a machine language interface, etc.

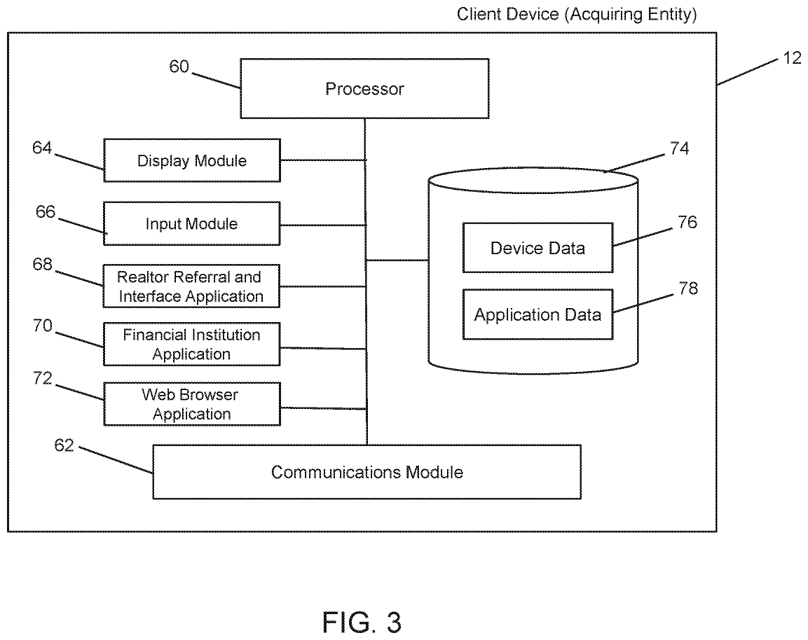

In FIG. 3, an example configuration of the client device 12 is shown. In certain embodiments, the client device 12 may include one or more processors 60, a communications module 62, and a data store 74 storing device data 76 and application data 78. Communications module 62 enables the client device 12 to communicate with one or more other components of the computing environment 8, such as platform 10 or realtor devices 20 (or one of its components), via a bus or other communication network, such as the communication network 14. While not delineated in FIG. 3, the client device 12 includes at least one memory or memory device that can include a tangible and non-transitory computer-readable, medium having stored therein computer programs, sets of instructions, code, or data to be executed by processor 60. FIG. 3 illustrates examples of modules and applications stored in memory on the client device 12 and operated by the processor 60. It can be appreciated that any of the modules and applications shown in FIG. 3 may also be hosted externally and be available to the client device 12, e.g., via the communications module 62.

In the example embodiment shown in FIG. 3, the client device 12 includes a display module 64 for rendering GUIs and other visual output on a display device such as a display screen, and an input module 66 for processing user or other inputs received at the client device 12, e.g., via a touchscreen, input button, transceiver, microphone, keyboard, etc. The client device 12 may also include a realtor referral and interface application 68, which may be a customized app provided by the platform 10 for use by the entities in the computing environment 8. Similarly, the client device 12 may include a financial institution application 70 provided by their financial institution system 16, e.g., for performing mobile banking operations. The client device 12 in this example embodiment also includes a web browser application 72 for accessing Internet-based content, e.g., via a mobile or traditional website. The data store 74 may be used to store device data 76, such as, but not limited to, an IP address or a MAC address that uniquely identifies client device 12 within environment 8. The data store 74 may also be used to store application data 78, such as, but not limited to, login credentials, user preferences, cryptographic data (e.g., cryptographic keys), etc.

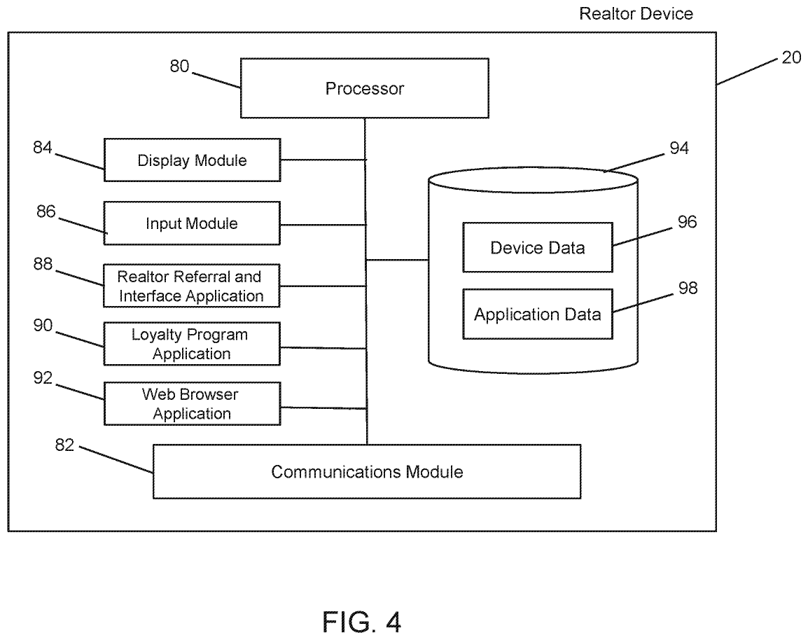

In FIG. 4, an example configuration of the realtor device 20 is shown. In certain embodiments, the realtor device 20 may include one or more processors 80, a communications module 82, and a data store 94 storing device data 96 and application data 98. Communications module 82 enables the realtor device 20 to communicate with one or more other components of the computing environment 8, such as platform 10 or client devices 12 (or one of its components), via a bus or other communication network, such as the communication network 14. While not delineated in FIG. 4, the realtor device 20 includes at least one memory or memory device that can include a tangible and non-transitory computer-readable medium having stored therein computer programs, sets of instructions, code, or data to be executed by processor 80. FIG. 4 illustrates examples of modules and applications stored in memory on the realtor device 20 and operated by the processor 80. It can be appreciated that any of the modules and applications shown in FIG. 4 may also be hosted externally and be available to the realtor device 20, e,g., via the communications module 82.

In the example embodiment shown in FIG. 4, the realtor device 20 includes a display module 84 for rendering GUIs and other visual output on a display device such as a display screen, and an input module 86 for processing user or other inputs received at the realtor device 20, e.g., via a touchscreen, input button, transceiver, microphone, keyboard, etc. The realtor device 20 may also include the realtor referral and interface application 88. Similarly, the realtor device 20 may include a loyalty program application 90 provided by a loyalty program to manage a loyalty program provided by the realtor or financial institution, or on behalf of a third party loyalty program. The realtor device 20 in this example embodiment also includes a web browser application 92 for accessing Internet-based content, e.g., via a mobile or traditional website. The data store 94 may be used to store device data 96, such as, but not limited to, an IP address or a MAC address that uniquely identifies realtor device 20 within environment 8. The data store 94 may also be used to store application data 98, such as, but not limited to, login credentials, user preferences, cryptographic data (e.g., cryptographic keys), etc.

It will be appreciated that only certain modules, applications, tools and engines are shown in FIGS. 2 to 4 for ease of illustration and various other components would be provided and utilized by the client device 12, realtor device 20 and platform 10, as is known in the art.

It will also be appreciated that any module or component exemplified herein that executes instructions may include or otherwise have access to computer readable media such as storage media, computer storage media, or data storage devices (removable and/or non-removable) such as, for example, magnetic disks, optical disks, or tape. Computer storage media may include volatile and non-volatile, removable and non-removable media implemented in any method or technology for storage of information, such as computer readable instructions, data structures, program modules, or other data. Examples of computer storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by an application, module, or both. Any such computer storage media may be part of any of the servers in platform 10 or financial institution system 16, client device 12, or realtor device 20, or accessible or connectable thereto. Any application or module herein described may be implemented using computer readable/executable instructions that may be stored or otherwise held by such computer readable media.

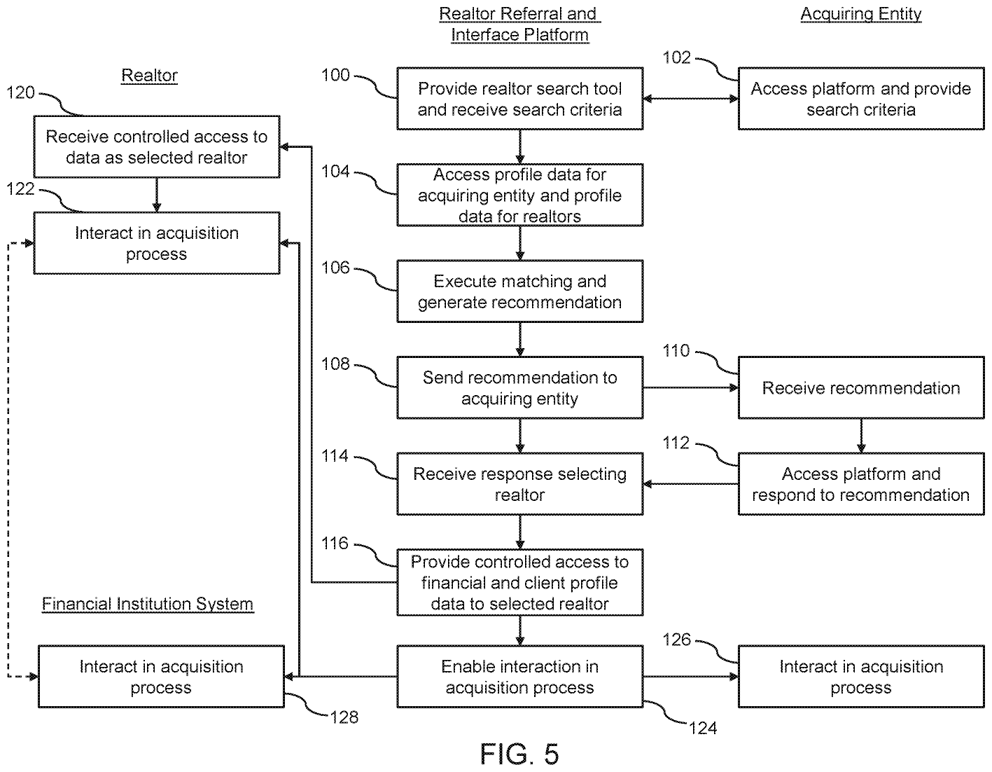

Referring to FIG. 5, an example embodiment of computer executable instructions for processing profile data to generate recommendations and interface acquiring entities with realtors is shown. At block 100, the platform 10 provides a realtor search tool via the realtor search module 50 and receives search criteria from the acquiring entity. The search criteria may be received by the acquiring entity accessing the platform 10 via the realtor referral and interface application 68 at block 102, which may include opening or otherwise accessing a realtor search option, tab, page, or tool within the realtor referral and interface application 68. The realtor search can be initiated by the user via the client device 12 or can be initiated by an input or event detected or inferred by an application or process. For example, a user may access a website provided by the platform 10, may download and install an app on their client device 12 via an app store, or may be directed to the platform 10 by clicking a link or redirection mechanism embedded in another application such as the financial institution application 70, an advertisement or other media content. Such an app may correspond to the realtor referral and interface application 68 herein described.

At block 104, the platform 10 accesses profile data for the acquiring entity, namely the client profile data 24 for that user. The platform 10 may also access the realtor data 26. The realtor data 26 accessed in block 104 can include all the realtor data 26 or the realtor data 26 may be filtered based on a set of filtering criteria such as one or more of the search criteria. With the search criteria, realtor data 26, and corresponding client data 24 for the user, the platform 10 uses the recommendation engine 36 and machine learning engine 38 to execute a matching process and generate one or more recommendations. At block 108, a generated recommendation (or list of best matches) is sent to the acquiring entity. The recommendation may be in the form of an electronic communication or alert or may be displayed actively within a browser or app currently being used by the client device 12 for the acquiring entity. At block 110 the recommendation is received by the acquiring entity.

At block 112, the acquiring entity accesses the platform 10, e.g., using the realtor referral and interface application 68 to respond to the recommendation. The response may include an acceptance or refusal of the recommended realtor. The platform 10 may also send a set of recommendations with a plurality of recommended realtors, with an option to accept, refuse or rank these recommended realtors for a second level matching.

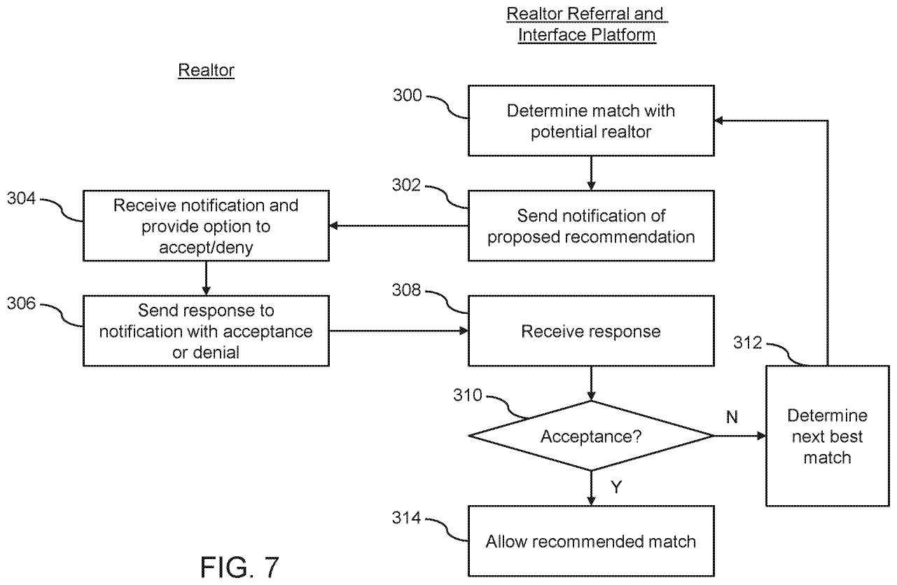

At block 114, the platform 10 receives the response to the recommendation. It will be appreciated that blocks 106-114 may be performed iteratively. For example, blocks 106-114 may be performed once for each realtor ranked as an acceptable match by the acquiring entity. Alternatively, blocks 106-114 may be performed only once as illustrated in FIG. 5, with the response by the user used by the platform 10 to automatically arrange the best possible realtor match based on realtor availability and those rankings. It will be appreciated that the process shown in FIG. 5 may be reconfigured to include a sub-process to allow realtors to confirm the recommendation as shown in FIG. 7 described below. When realtors are required to confirm the recommendation, the platform 10 may be required to iteratively generate recommendations until a match is accepted by both parties. However, it will be appreciated that the platform 10 may require the realtors to opt in automatically accept recommended matches, if accepted by the acquiring entity.

At block 116, the platform 10 provides controlled access to financial data 18 and client profile data 24 to the selected realtor. For example, the platform 10 may have access to an affordability metric or financial health metric that it has permission to share with the realtor. Controlled access to the client profile data 24 may include providing only certain information required to begin an engagement with the acquiring entity. When blocks 106-114 are performed iteratively, where selected realtors confirm that they also accept the matched result, the amount of data released to the realtor at block 116 may be less than if the realtor match is automatically confirmed.

At block 120 the realtor receives the controlled access to the data, as the selected realtor and in this example assumes that the realtor selection is automatically confirmed or a sub-process has been completed to have the realtor accept the match. With controlled access to the data the realtor may interact in the acquisition process at block 122, e.g., by scheduling viewings, sending home listings to the acquiring entity, initiating a pre-approval process via the financial institution system 16, etc. As illustrated in dashed lines, the realtor may engage with the financial institution directly when interacting in the acquisition process, e.g., to obtain a credit score or mortgage pre-approval.

At block 124, the platform 10 may also enable interaction in the acquisition process to the realtor at block 122, to the acquiring entity at block 126, and to the financial institution system 16 at block 128. For example, viewings and offers can be facilitated via the platform 10, e.g., by exchanging communications, sharing documents, and building out further members for the homebuying team.

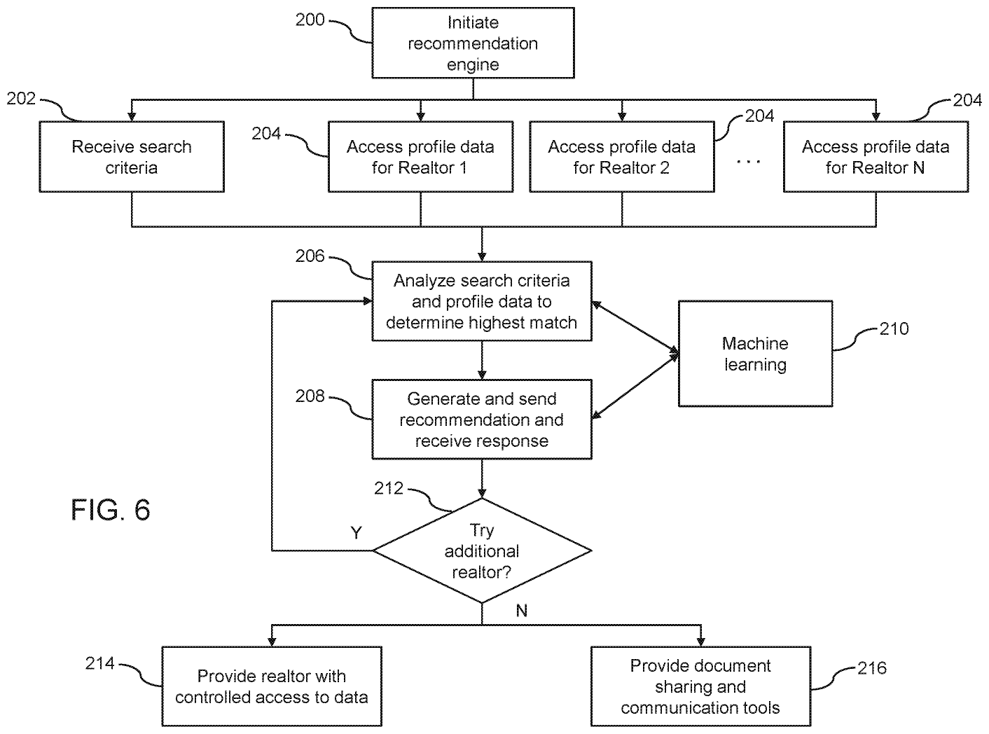

Referring to FIG. 6, an example embodiment of computer executable instructions for executing matching and recommendation processes is shown. At block 200 the platform 10 initiates the recommendation engine 36 as herein described. At block 202, the recommendation engine 36 uses the databases interface module 34 to access the client profile data 24 associated with the acquiring entity or more generally the user as herein described.

At block 204, the recommendation engine 36 may also use the databases interface module 34 to access the realtor data 26 for each realtor that is to be analyzed for the matching process. The recommendation engine 36 uses the machine learning engine 38 to execute machine learning processes at block 210 as herein described. This may include analyzing the data accessed in blocks 202 and 204 to classify data such that relevant parameters can be identified and used to determine a highest match between the content in the client profile data 24 and the content in the realtor data 26 at block 206. The matching process implemented at block 206 may be used to generate and send one or more recommendations and to receive one or more responses from the acquiring entity at block 208.

At block 208, various recommendation processes can be utilized. For example, the realtor can be automatically matched when accepted by the user. In another example embodiment, multiple ranked matches may be sent to the user and multiple selections used to iteratively confirm one match based on the acceptance by the corresponding realtor. When performed iteratively, the matching process may be repeated if a matched realtor is unavailable or does not accept the recommended match. As such, the process shown in FIG. 6 may determine at block 212 whether any additional realtors should be matched. If so, blocks 206 to 210 may be repeated in order to find an accepted match. If not, the platform 10 may provide the realtor with the controlled access to the data (as described herein) at block 214 and populate the document sharing tool 48 and communication tool 46 at block 216. Block 216 may also include populating dashboards through the realtor referral and interface application 68, initiating communication interfaces such as chats using the communications tool 46, and creating repositories for sharing documents using the document sharing tool 48.

In addition to obtaining an acceptance of a recommendation by the acquiring entity, the platform 10 may also engage with the potential realtors to enable the potential realtors to accept or effectively “vet” the acquiring entity, or otherwise pre-empt an unsuitable or conflicted match. For example, successful realtors in a certain geographic area may inherently end up being highly matched with many potential home buyers but not have suitable availability. Moreover, the platform 10 can benefit the realtors as well as the acquiring entities and therefore the realtors may be given an opportunity to be more selective in how the matching occurs, e.g., such that more popular realtors obtain the higher-value connections. Moreover, the controlled access to the financial data 18 may allow a realtor to determine if the prospective home buyer can afford to engage in the home buying process and/or if the prospective home buyer has realistic expectations given their financial health.

Referring to FIG. 7, an example embodiment of computer executable instructions for communicating proposed recommendations to realtors is shown. At block 300 the platform determines a match with a potential realtor as described herein. At block 302 a notification of the proposed recommendation may be sent to the matched realtor. The realtor receives the notification at block 304, e.g., via the realtor referral and interface application 88 on the realtor device 20 and provides the user with an option to accept or deny the match. Block 304 may include some limited information such as financial viability, income range, profession, and search criteria (e.g., a home versus a condo, the location, etc.) that can allow the realtor to assess whether the match is acceptable to them.

At block 306, the realtor sends a response to the notification via the realtor device 20 with such an acceptance or denial. The platform 10 receives the response at block 308 and determines at block 310 whether the matched realtor has accepted the match. If not, the process returns to block 300 to attempt to confirm a next match at block 312. It will be appreciated that block 312 may include using the recommendation engine 36 to find a next best match or may select a second match that was accepted by the acquiring entity. If the realtor has accepted the match, at block 314, the platform 10 may allow the recommended match. It will be appreciated that the process shown in FIG. 7 may be performed before the recommendations are provided to the acquiring entity, after the recommendations are accepted by the acquiring entity, or in parallel in an iterative manner. That is, the use of the recommendation engine 36 and processes by which the acquiring entities and realtors accept the recommendations generated by the platform 10 may be flexibly applied to suit different deployments, user preferences and circumstances.

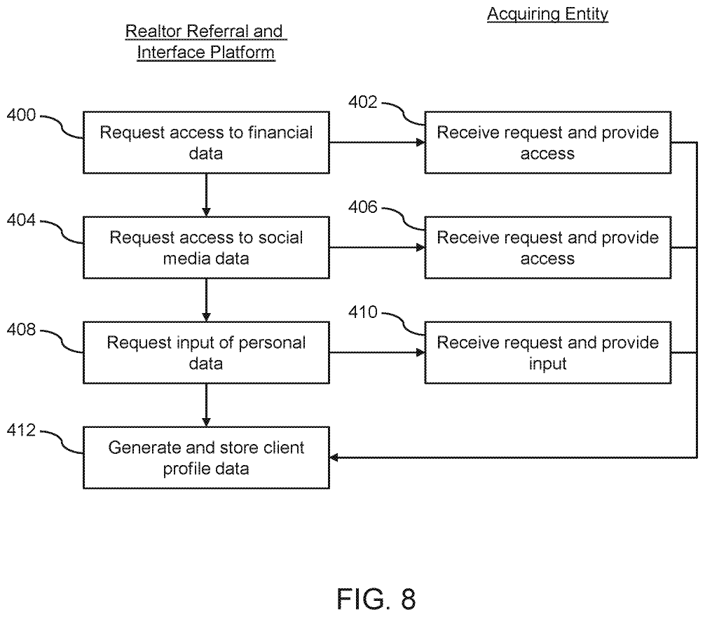

The platform 10 may obtain access to certain client profile data 24 that is associated with a user. Referring to FIG. 8, an example embodiment of computer executable instructions for obtaining access to data for populating a client profile is shown.

At block 400 the platform 10 requests access to financial data 18 and provides this request to the acquiring entity. At block 402 the acquiring entity receives the request for financial data 18 and provides access to the platform 10 in this example embodiment. It can be appreciated that the financial data 18 can be accessed directly when the platform 10 is associated with or provided directly by the financial institution system 16. The financial data 18 may also be entered by the acquiring entity when establishing a profile with the platform 10, e.g., via a questionnaire or other input mechanism. Full or partial access to the financial institution system 16 may also be provided to enable the client profile data 24 to have access to current and periodically changing financial data 18.

At block 404 the platform 10 requests access to social media data to obtain preferences and personality traits, searching and viewing histories, “likes”, reposts, among other things, and provides this request to the acquiring entity. At block 406 the acquiring entity receives the request for social media data and provides access to the platform 10 in this example embodiment. Providing access in this example embodiment may include providing sign-in credentials or a permission to enable the platform 10 to directly access the social media data automatically and periodically. The permission may be an opt-in by the acquiring entity that the platform 10 can utilize publicly available social media data for that user. Access to private social media data can also be provided with the credentials.

At block 408 the platform 10 requests the input of certain personal data, to obtain other preferences and personality traits, or other data not available through social media, and provides this request to the acquiring entity. At block 410 the acquiring entity receives the request for the input of personal data and provides input to the platform 10 in this example embodiment. Providing input of personal information may include a questionnaire or survey or other input mechanism provided to the acquiring entity, e.g., via the realtor referral and interface application 68.

At block 412 the platform 10 generates and stores the client profile data 24 for that acquiring entity via the databases interface module 34. The process shown in FIG. 8 may be initiated when registering a new user, may be periodically performed to update and refresh the client profile data 24, or both.

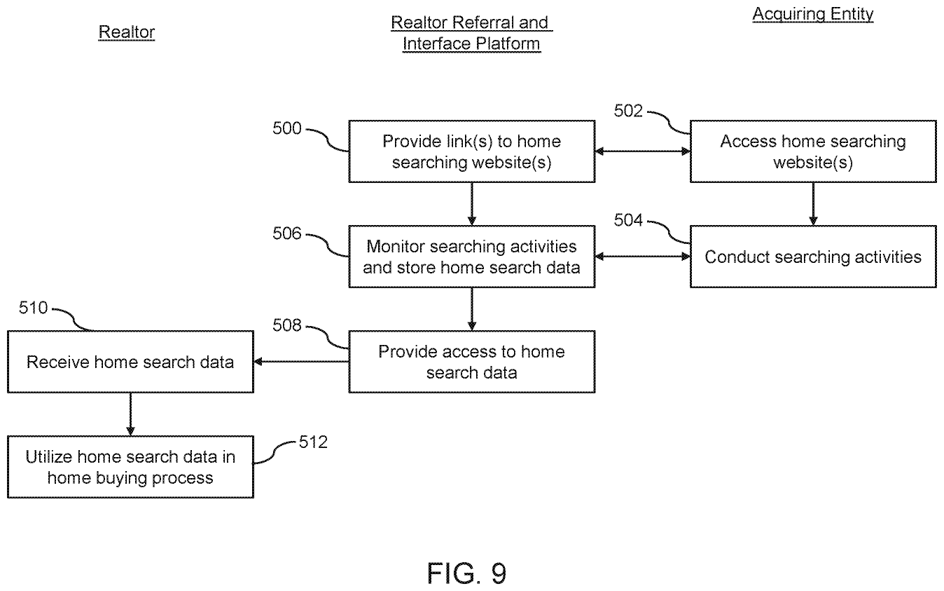

The platform 10 may also provide access to, or otherwise be associated with, a real estate listing site or service to enable the platform 10 to monitor search activities. Referring to FIG. 9, an example embodiment of computer executable instructions for monitoring and storing home search data and providing home search data to realtors is shown. At block 500, the platform 10 provides one or more links to home searching websites, such as a real estate listing website. The platform 10 may provide such links via the realtor referral and interface application 68. The acquiring entity may access the one or more home searching websites at block 502 and conduct searching activities at block 504.

It will be appreciated that the acquiring entity may also access the home searching website(s) independently of the link(s) provided at block 500. Moreover, accessing one of the home searching websites may initiate a notification to the platform 10 to begin monitoring such searching activities, and storing the home search data at block 506. In some example embodiments, access to the home searching websites may be used to monitor searching activities and conduct additional searches by the platform 10, e.g., as described in co-pending U.S. Patent Application No. [19007] filed on Feb. 13, 2019 and entitled “System and Method for Searching and Monitoring Assets Available for Acquisition”, the contents of which are incorporated herein by reference.

At block 508, access to the stored home search data may be provided to the realtor. The home search data may be used by the realtor in determining whether to accept a recommended match as herein described. The home search data may also be provided when available (e.g., periodically according to when the acquiring entity performs the searching activities) to assist the realtor in the home searching and buying process. For example, the platform 10 may be leveraged to automatically feed the home search data to the realtor to minimize the amount of effort required by the acquiring entity to convey this information to the realtor. The realtor receives the home search data at block 510 and utilizes the home search data in the home buying process at block 512.

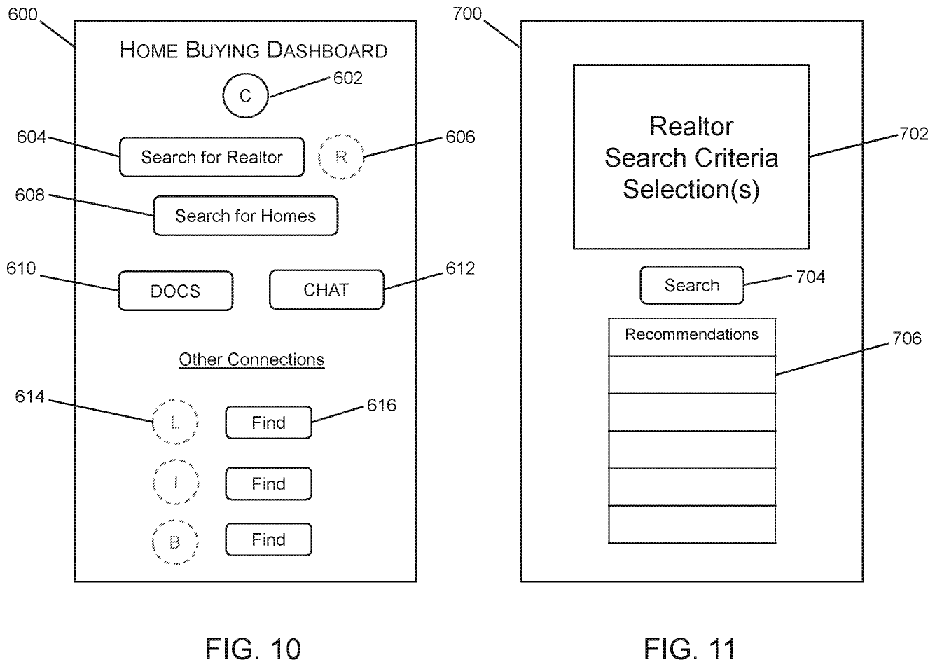

Referring to FIG. 10, an example of a GUI of a home buying dashboard 600 is shown. The home buying dashboard 600 may be provided via the realtor referral and interface application 68. The home buying dashboard 600 is associated with the client device 12 and its user, and in this example embodiment identifies the user with a user profile image 602 containing the letter “C”. It will be appreciated that the user profile image 602 may be a character, avatar, photo, emoji, or other visual element. The dashboard 600 also includes a Search for Realtor option 604 that may be used to initiate a realtor search process as herein described. A realtor profile image 606 is shown greyed out and in dashed lines to indicate that such an image 606 will be populated upon being matched with a realtor.

The dashboard 600 also includes a Search for Homes option 608 that may be used to provide access to the one or more home searching websites as described above. The dashboard 600 may also include a DOCS option 610, which may be selected to access the document sharing tool 48, and a CHAT option 612, which may be selected to access the communications tool 46. A series of advisor profile images 614 may also be displayed, with each image 614 being populated (shown in dashed grey in FIG. 10 to illustrate a yet-to-be-added advisor type) as members are added to a team of advisors via the platform 10. It will be appreciated that the platform 10 may also be used to connect and interface the acquiring entity with other advisors, as described in co-pending U.S. Patent Application No. [19005] filed on Feb. 13, 2019 and entitled “System and Method for Interfacing Entities Engaged in Exchange Activities”, the contents of which are incorporated herein by reference.

Selecting the Search for Realtor option 604 may initiate a GUI for a realtor search tool 700 as illustrated in FIG. 11. The realtor search tool 700 may also be provided via the realtor referral and interface application 68. The realtor search tool 700 includes a search criteria portion 702 that includes one or more mechanisms to enable a user to select or enter suitable search criteria. For example, the search criteria portion 702 may provide text search boxes to enter keywords, selection boxes for predetermine criteria, radio buttons for options criteria, etc. The realtor search tool 700 also include a Search button 704 to initiate a search, and a list 706 of recommended realtors that match the search. It can be appreciated that the list 706 may include an option to select from the list, an option to select multiple ones from the list 706, rank one or more of the recommended realtors in the list 706, or a combination of these options. The list 706 may therefore be used to provide the output of the recommendation engine 36 and may correspond to the notification of the recommended realtor(s) as herein described. Moreover, the list 706 may provide the ability to respond to the notification.

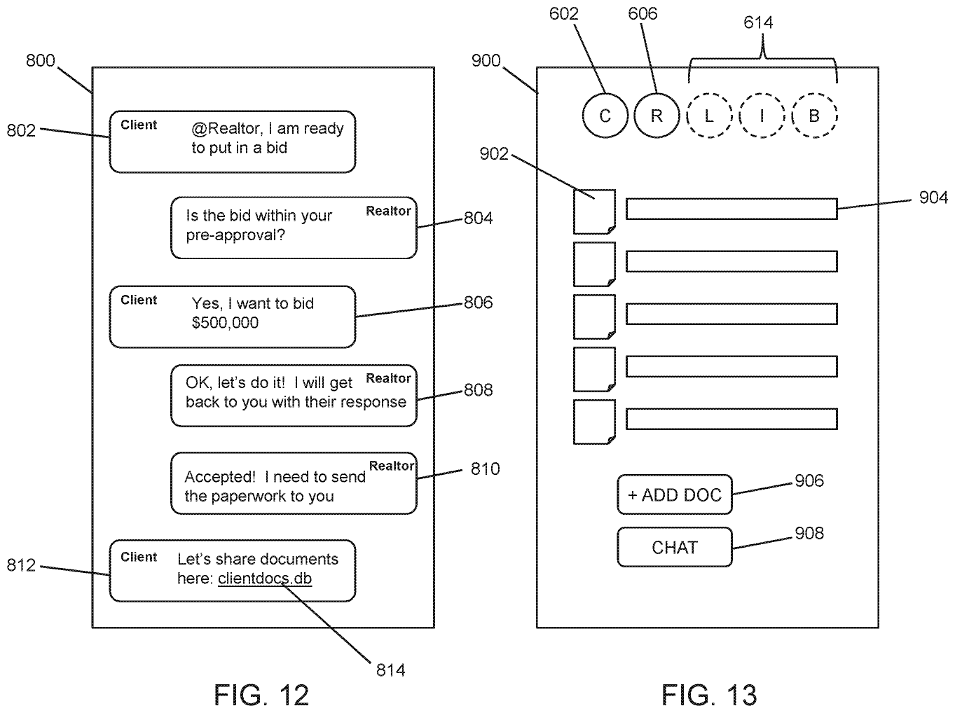

FIG. 12 is an example embodiment of a GUI of a virtual chat session 800 provided via the communications tool 46. The chat session 800 allows the realtor to collaboratively communicate with the acquiring entity for participating in the transaction or other exchange being pursued by the acquiring entity. In this example embodiment, a first client message 802 is directed to the realtor indicating that: “@Realtor, I am ready to put in a bid”. The chat session 800 may therefore be used by the user to communicate with the realtor and initiate an acquisition activity. A first realtor message 804 is sent by the realtor that indicates: “Is the bid within your pre-approval”. A second client message 806 is sent by the acquiring entity that indicates: “Yes, I want to bid $500,000”. The realtor may then reply with a second realtor message 808 that indicates: “OK, let's do it! I will get back to you with their response”. The virtual chat session 800 may therefore be used by the acquiring entity and the realtor to effectively communicate during the acquisition process.

After some time elapses, a third realtor message 810 is displayed which indicates: “Accepted! I need to send the paperwork to you”. The acquiring entity would then be able to react and respond quickly and move the process along. In this example, a third client message is sent, which indicates: “Let's share documents here: . . . ”, with a link 814 to the document sharing tool 48. The chat session 800 may therefore also be used to navigate between tools and features within the platform 10.

FIG. 13 is an example of a document sharing GUI 900 of a document sharing tool 48. The document sharing tool 48 may be used by the acquiring entity, the realtor, and potentially other advisors to collaborate, share, edit, and exchange documents, and maintain a single repository for the home buying process. In the example embodiment shown in FIG. 13, the client image 602, realtor image 606, and other advisor images 614 may be used to identify who has access to the documents. It will be appreciated that the access control module 44 may also be used to control which entity can see what document. The document sharing GUI 900 may also include a list of documents 902 and descriptors 904 for each document 902, providing an ability to view and select individual files. The document sharing GUI 900 may also include an +ADD DOC option 906 that may be selected to upload a new document or file to the document sharing tool 48, and a CHAT option 908 to navigate between the document sharing GUI 900 and the chat session 800.

It will be appreciated that the examples and corresponding diagrams used herein are for illustrative purposes only. Different configurations and terminology can be used without departing from the principles expressed herein. For instance, components and modules can be added, deleted, modified, or arranged with differing connections without departing from these principles.

The steps or operations in the flow charts and diagrams described herein are just for example. There may be many variations to these steps or operations without departing from the principles discussed above. For instance, the steps may be performed in a differing order, or steps may be added, deleted, or modified.

Although the above principles have been described with reference to certain specific examples, various modifications thereof will be apparent to those skilled in the art as outlined in the appended claims.

1. A device for interfacing acquiring entities and realtors, the device comprising:
a processor;
a communications module coupled to the processor; and
a memory coupled to the processor, the memory storing computer executable instructions that when executed by the processor cause the processor to:
provide via the communications module an electronic platform comprising a first interface for interacting with one or more realtors, a second interface for interacting with acquiring entities via acquiring entity electronic communication devices, and a third interface for communication with a financial institution computing system;
receive via the third interface of the communications module a first signal including financial data and a second signal including personal profile data for each acquiring entity associated with the electronic platform;
store a database of realtor profile data for each of a plurality of the realtors, the realtor profile data comprising a plurality of metrics;
provide via the second interface of the communications module a realtor search tool to receive search criteria;
receive via the second interface of the communications module a third signal from the acquiring entity including search criteria and use the received search criteria and the realtor profile data to generate a search result list comprising at least one recommended realtor that satisfies at least one search criterion and satisfies at least one realtor metric;
send via the second interface of the communications module a fourth signal including the search result list to the acquiring entity electronic communication device;
receive via the second interface of the communications module a fifth signal including a request for a selected realtor;
provide controlled access to the financial data and the personal profile data to the selected realtor via the first interface of the communications module; and
enable via the third interface of the communications module at least one step in an acquisition process to be electronically executed or electronically initiated with the financial institution computing system, using the first interface or the second interface of the communications module.

2. The device of claim 1, wherein the computer executable instructions further cause the processor to:
provide the plurality of realtors with limited access to the financial and personal profile data to vet at least one acquiring entity according to financial viability.

3. The device of claim 2, wherein the computer executable instructions further cause the processor to:
receive via the communications module a sixth signal including a request to omit a particular realtor from recommendations provided to at least one acquiring entity based on the vetting.

4. The device of claim 1, wherein the data provided to the selected realtor comprises data associated with a mortgage pre-approval.

5. The device of claim 1, wherein the at least one step in the acquisition process comprises initiating a mortgage approval process with the financial institution computing system.

6. The device of claim 5, wherein the at least one step in the acquisition process comprises a home appraisal associated with the mortgage approval process.

7. The device of claim 1, wherein the computer executable instructions further cause the processor to:
store home search data for at least one acquiring entity; and
provide access to the home search data to the selected realtor via the first interface of the communications module, to assist in a home buying process.

8. The device of claim 1, wherein the computer executable instructions further cause the processor to:
increase access to the financial and personal profile data for the selected realtor in response to at least one event.

9. The device of claim 8, wherein the at least one event comprises at least one of an agreement to represent the acquiring entity, an instruction or permission provided by the acquiring entity, and a regulatory requirement being satisfied.

10. The device of claim 1, wherein the computer executable instructions further cause the processor to:
enable at least one step in a real estate transaction associated with a financing to be executed or initiated using the first or second interface of the communications module.

11. The device of claim 10, wherein the at least one step in the real estate transaction comprises at least one of a purchase offer, a home inspection, and acquiring home insurance.

12. The device of claim 1, wherein the computer executable instructions further cause the processor to:
obtain realtor feedback via the second interface of the communications module; and
update the database of realtor profile data according to the feedback.

13. The device of claim 1, wherein the computer executable instructions further cause the processor to:
provide via the communications module a document sharing tool between the realtors and the acquiring entities that uses the first and second interfaces.

14. The device of claim 1, wherein the computer executable instructions further cause the processor to:
provide via the communications module a communication tool between the realtors and the acquiring entities that uses the first and second interfaces.

15. A method of interfacing acquiring entities and realtors, the method comprising:
providing via a communications module an electronic platform comprising a first interface for interacting with one or more realtors, a second interface for interacting with acquiring entities via acquiring entity electronic communication devices, and a third interface for communication with a financial institution computing system;
receiving via the third interface of the communications module a first signal including financial data and a second signal including personal profile data for each acquiring entity associated with the electronic platform;
storing a database of realtor profile data for each of a plurality of the realtors, the profile data comprising a plurality of metrics;
providing via the second interface of the communications module a realtor search tool to receive search criteria;
receiving via the second interface of the communications module a third signal from the acquiring entity including search criteria and use the received search criteria and the realtor profile data to generate a search result list comprising at least one recommended realtor that satisfies at least one search criterion and satisfies at least one realtor metric;
sending via the second interface of the communications module a fourth signal including the search result list to the acquiring entity electronic communication device;
receiving via the second interface of the communications module a fifth signal including a request for a selected realtor;
providing controlled access to the financial data and the personal profile data to the selected realtor via the first interface of the communications module; and
enabling via the third interface of the communications module at least one step in an acquisition process to be electronically executed or electronically initiated with the financial institution computing system, using the first interface or the second interface of the communications module.

16. The method of claim 15, further comprising:
providing the plurality of realtors with limited access to the financial and personal profile data to vet at least one acquiring entity according to financial viability.

17. The method of claim 16, further comprising:
receiving via the communications module a third signal including a request to omit a particular realtor from recommendations provided to at least one acquiring entity based on the vetting.

18. The method of claim 15, further comprising:
increasing access to the financial and personal profile data for the selected realtor in response to at least one event.

19. The method of claim 15, further comprising:
enabling at least one step in a real estate transaction associated with a financing to be executed or initiated using the first or second interface of the communications module.

20. A non-transitory computer readable medium for interfacing acquiring entities and realtors, the computer readable medium comprising computer executable instructions for:
providing via a communications module an electronic platform comprising a first interface for interacting with one or more realtors, a second interface for interacting with acquiring entities via acquiring entity electronic communication devices, and a third interface for communication with a financial institution computing system;
receiving via the third interface of the communications module a first signal including financial data and a second signal including personal profile data for each acquiring entity associated with the electronic platform;
storing a database of realtor profile data for each of a plurality of the realtors, the profile data comprising a plurality of metrics;
providing via the second interface of the communications module a realtor search tool to receive search criteria;
receiving via the second interface of the communications module a third signal from the acquiring entity including search criteria and use the received search criteria and the realtor profile data to generate a search result list comprising at least one recommended realtor that satisfies at least one search criterion and satisfies at least one realtor metric;
sending via the second interface of the communications module a fourth signal including the search result list to the acquiring entity electronic communication device;
receiving via the second interface of the communications module a fifth signal including a request for a selected realtor;
providing controlled access to the financial data and the personal profile data to the selected realtor via the first interface of the communications module; and
enabling via the third interface of the communications module at least one step in an acquisition process to be electronically executed or electronically initiated with the financial institution computing system, using the first interface or the second interface of the communications module.
